(19) United States
(12) Patent Application Publication
(10) Pub. No.: US 2026/0348509 A1
(43) Pub. Date: Nov. 5, 2026

(54) INSULATION SHIELD

(71) Applicant: Shannon Global Energy Solutions, North Tonawanda, NY (US)

(72) Inventor: Frank Kovacs, Grand Island, NY (US)

(21) Appl. No.: 19/195,789

(22) Filed: May 1, 2025

(51) Int. Cl. F16L 59/14; B32B 5/02; B32B 5/18; B32B 5/24; B32B 7/12

(52) U.S. Cl. CPC F16L 59/14; B32B 5/02; B32B 5/18; B32B 5/245; B32B 7/12; B32B 2255/02; B32B 2255/26; B32B 2266/0207; B32B 2266/08; B32B 2307/304

(57) ABSTRACT

An insulation shield comprising a flexible outer jacket having an inner surface and an outer surface, wherein the flexible outer jacket has a first attachment means affixed to the outer surface thereof and proximate a first end, an insulation core having an inner surface and an outer surface, wherein the outer surface of the insulation core is adhered to the inner surface of the flexible outer jacket, and a jacketing flap having an inner surface and an outer surface, wherein the jacketing flap extends from a second end of the flexible outer jacket, the jacketing flap has a second attachment means affixed to the inner surface of the jacketing flap, and the jacketing flap is arranged to removably attach to the first attachment means affixed to the outer surface of the flexible outer jacket.

### FIELD

The present invention relates to an insulation shield, specifically to a removable insulation shield for hot water and chilled water systems.

### BACKGROUND

In commercial and industrial buildings, structures that carry a fluid, e.g., hot water or chilled water systems, may be fitted with protective insulation to save energy, retain radiant heat, minimize required maintenance, and improve the surrounding work environment. Insulating preexisting components, e.g., water control valves, flanges, fittings, pumps, piping, complex equipment surfaces, heads, etc., is a practical way to improve energy efficiency and prevent issues like heat loss, condensation, and freezing. In some cases, preexisting system components are fitted with insulation over their outer surfaces, commonly done with a foam piece that surrounds the entirety of the component. In other instances, system components may have built-in insulation.

For system components that have built-in insulation, the insulation material is typically integrated into the components during the manufacturing process, creating a seamless barrier with a rigid outer shell that minimizes thermal bridging and prevents condensation. The insulation materials used in these components can vary, but common options include foam, fiberglass, and mineral wool. These materials have thermal resistance properties which help maintain the temperature of the fluid being transported.

A known issue with built-in insulation is the presence of uninsulated components, such as valves, drains, variable diameter connectors, valve levers, etc. Typically, these components cannot utilize built-in insulation, as the shape and configuration of the component prevents the usage of built-in insulation. Further, if insulation is fitted over the outer surfaces of these components, in many cases, the insulation has to be forcibly cut and torn open to provide access or visibility to these components, creating waste and uninsulated sections.

For example, U.S. Pat. No. 7,947,354 discloses a thermal insulating blanket including an insulating core encased in a fibrous envelope with at least one breather vent in the upper portion of the outer envelope cover, and at least one drain opening in the lower portion of the outer enveloping cover. Blankets of this type are typically used in sections of piping/conduit having a valve. Specifically, a front portion of the blanket covers a portion of the conduit going to the valve, a rear portion of the blanket covers a portion of the conduit leaving the valve, and an upper portion of the blanket covers the valve, leaving an opening for a valve control, such as a turning knob.

Therefore, there is a long-felt need to provide an insulation shield that can be attached to an uninsulated portion of a fluid carrying system component that is lightweight and easy to remove and reinstall, where the insulation shield is designed to also removably cover uninsulated components having irregular shapes and configurations. Further, there is a long-felt need to provide an insulation shield that affords easy access and visibility to those components.

### SUMMARY

At the outset it should be understood that while the following disclosure, figures, and/or claims, etc., describe subject matter including one or more aspects described as either alone or in combination with one or more other aspects, the subject matter of the instant disclosure is not intended to be so limited. That is, the instant disclosure, figures, and claims are intended to encompass the various aspects described herein, either alone or in one or more combinations with one another. For example, while the instant disclosure may describe and illustrate a first aspect, a second aspect, and a third aspect in a manner such that the first aspect is only specifically described and illustrated relative to the second aspect, or the second aspect is only described and illustrated relative to the third aspect, the instant disclosure and illustrations are not intended to be so limiting and may encompass the first aspect alone, the second aspect alone, the third aspect alone, or one or more combinations of the first, second, and/or third aspects, e.g., the first aspect and the second aspect, the first aspect and the third aspect, the second and third aspect, or the first, second and third aspects.

According to aspects herein, the present invention generally comprises an insulation shield comprising a flexible outer jacket having an inner surface and an outer surface, wherein the flexible outer jacket has a first attachment means affixed to the outer surface thereof and proximate a first end, an insulation core having an inner surface and an outer surface, wherein the outer surface of the insulation core is adhered to the inner surface of the flexible outer jacket, and a jacketing flap having an inner surface and an outer surface, wherein the jacketing flap extends from a second end of the flexible outer jacket, the jacketing flap has a second attachment means affixed to the inner surface of the jacketing flap, and the jacketing flap is arranged to removably attach to the first attachment means affixed to the outer surface of the flexible outer jacket.

In some embodiments, the present invention comprises the aforementioned insulation shield wherein the flexible outer jacket is comprised of polyester cloth.

In some embodiments, the present invention comprises the aforementioned insulation shield wherein the polyester cloth is vinyl coated.

In some embodiments, the present invention comprises the aforementioned insulation shield wherein the insulation core is comprised of closed cell elastomeric foam.

In some embodiments, the present invention comprises the aforementioned insulation shield wherein the closed cell elastomeric foam comprises closed cell ethylene-propylene-diene monomer based rubber elastomeric foam.

In some embodiments, the present invention comprises the aforementioned insulation shield wherein the outer surface of the insulation core is adhered to the inner surface of the flexible outer jacket using acrylic pressure sensitive adhesive.

In some embodiments, the present invention comprises the aforementioned insulation shield wherein both of the attachment means are arranged as a single co-linear pair.

In some embodiments, the present invention comprises the aforementioned insulation shield wherein the attachment means comprise hook and loop fasteners.

In some embodiments, the present invention comprises the aforementioned insulation shield further comprising a drain grommet, wherein the drain grommet is positioned within a lower portion of the insulation shield.

In some embodiments, the present invention comprises the aforementioned insulation shield wherein the outer surface of the flexible outer jacket has a label for identification and location purposes for a component that the insulation shield is covering.

In some embodiments, the present invention comprises the aforementioned insulation shield wherein the flexible outer jacket extends beyond the insulation core and the flexible outer jacket is operatively arranged to allow the flexible outer jacket of multiple insulation shields to overlap when positioned adjacently around structures for carrying a fluid, providing no open gap between the insulation cores of each insulation shield.

In some embodiments, the present invention comprises the aforementioned insulation shield further comprising a first cutout within the flexible outer jacket and the insulation core proximate the first end of the flexible outer jacket, and a second cutout within the flexible outer jacket and the insulation core proximate the second end of the flexible outer jacket, wherein the first cutout divides the first attachment means into a first pair of attachment means and the second cutout divides the second attachment means into a second pair of attachment means, and wherein when the first pair of attachment means are engaged with the second pair of attachment means an aperture is formed therebetween.

In some embodiments, the present invention comprises the aforementioned insulation shield further comprising the outer surface of the flexible outer jacket having one or more attachment means thereon within the periphery of the outer surface of the flexible outer jacket.

In some embodiments, the present invention comprises the aforementioned insulation shield further comprising a secondary insulation shield removably attached over the aperture formed when the first and second pair of attachment means are engaged.

In some embodiments, the present invention comprises the aforementioned insulation shield wherein the secondary insulation shield further comprises a flexible outer jacket comprised of vinyl coated polyester cloth, the outer jacket having an inner surface and an outer surface, an insulation core comprised of closed cell ethylene-propylene-diene monomer based rubber elastomeric foam, the insulation core having an inner surface and an outer surface, wherein the outer surface of the insulation core is adhered to the inner surface of the flexible outer jacket using acrylic pressure sensitive adhesive, an aperture, and attachment means operatively arranged to engage the one or more attachment means located on the outer surface of the flexible outer jacket within the periphery of the flexible outer jacket.

The present invention also comprises an insulation shield, comprising a flexible outer jacket comprised of vinyl coated polyester cloth, the outer jacket having an inner surface and an outer surface, an insulation core comprised of closed cell ethylene-propylene-diene monomer based rubber elastomeric foam, the insulation core having an inner surface and an outer surface, wherein the outer surface of the insulation core is adhered to the inner surface of the outer jacket using acrylic pressure sensitive adhesive, and one or more jacketing flaps extending from a periphery of the outer jacket, the jacketing flaps further comprising attachment means thereon.

In some embodiments, the present invention comprises the aforementioned insulation shield wherein the attachment means comprise hook and loop fasteners.

In some embodiments, the present invention comprises the aforementioned insulation shield further comprising a drain grommet, wherein the drain grommet is positioned within a lower portion of the insulation shield.

In some embodiments, the present invention comprises the aforementioned insulation shield wherein the outer surface of the flexible outer jacket has a label for identification and location purposes for a component that the insulation shield is covering.

In some embodiments, the present invention comprises the aforementioned insulation shield wherein the flexible outer jacket extends beyond the insulation core and the flexible outer jacket is operatively arranged to allow the flexible outer jacket of multiple insulation shields to overlap when positioned adjacently around structures for carrying a fluid, providing no open gap between the insulation cores of each insulation shield.

A general object of the present invention is to provide an insulation shield that can be removably attached to an uninsulated portion of a structure for carrying a fluid, where the insulation shield is designed to also removably cover uninsulated components and afford access and visibility to those components.

Another object of the present invention is to provide a lightweight insulation shield with minimal components designed to save energy, retain radiant heat, minimize required maintenance, and improve the surrounding work environment.

A further object of the present invention is to provide an insulation shield that is capable of withstanding extreme conditions, is flexible and easy to identify, install, remove and reinstall, and allows quick access for equipment service.

These and other objects, features, and advantages of the present invention will become readily apparent upon a review of the following detailed description of the present invention in view of the drawings and appended claims.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a perspective view of insulation shield 10 installed around pipe 7;

FIG. 2 is a perspective view of insulation shield 10 shown in FIG. 1, opened to show the layered construction and attachment means of insulation shield 10;

FIG. 3 is a top cross-sectional view of insulation shield 10 shown in FIG. 1;

FIG. 4 is a perspective view of another embodiment of the present invention comprising insulation shield 20a and secondary insulation shield 20b;

FIG. 5A is a side view of insulation shield 20a shown in FIG. 4, in a flattened uninstalled configuration;

FIG. 5B is a side view of secondary insulation shield 20b shown in FIG. 4, in a flattened uninstalled configuration;

FIG. 5C is a side view of insulation shield 10 and insulation shield 20a showing the overlapping of the outer jackets of each insulation shield;

FIG. 6 is a top cross-sectional view of insulation shield 20a taken generally along line 6-6 shown in FIG. 5A; and,

FIG. 7 is a perspective view of another embodiment of the present invention comprising insulation shield 30.

### DETAILED DESCRIPTION

At the outset, it should be appreciated that like drawing numbers on different drawing views identify identical, or functionally similar, structural elements. It is to be understood that the claims are not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the claims. Those in the art will understand that any suitable material, now known, or hereafter developed, may be used in forming the present invention described herein.

Unless defined otherwise, all technical and scientific terms used herein have the same meaning as commonly understood to one of ordinary skill in the art to which this disclosure pertains. It should be understood that any methods, devices or materials similar or equivalent to those described herein can be used in the practice or testing of the example embodiments.

It should be noted that the terms “including,” “includes,” “having,” “has,” “contains,” and/or “containing,” should be interpreted as being substantially synonymous with the terms “comprising” and/or “comprises.”

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. The term “approximately” is intended to mean values within ten percent of the specified value.

It should be understood that use of “or” in the present application is with respect to a “non-exclusive” arrangement, unless stated otherwise. For example, when saying that “item x is A or B,” it is understood that this can mean one of the following: (1) item x is only one or the other of A and B; (2) item x is both A and B. Alternately stated, the word “or” is not used to define an “exclusive or” arrangement. For example, an “exclusive or” arrangement for the statement “item x is A or B” would require that x can be only one of A and B. Furthermore, as used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element.

Moreover, as used herein, the phrases “comprises at least one of” and “comprising at least one of” in combination with a system or element is intended to mean that the system or element includes one or more of the elements listed after the phrase. For example, a device comprising at least one of: a first element; a second element; and, a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element. A similar interpretation is intended when the phrase “used in at least one of:” or “one of:” is used herein.

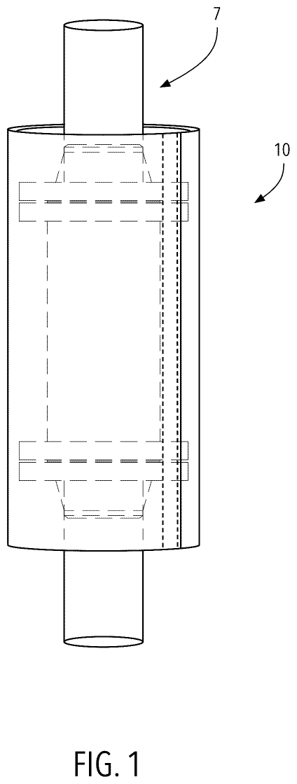

Adverting now to the figures, FIG. 1 is a perspective view of insulation shield 10 installed around pipe 7. Insulation shield 10 is designed to be installed around structures for carrying a fluid, e.g., a pipe, tube, conduit or the like. Preferably, the shield is intended for use in insulating structures that carry a fluid. The fluid can be, but is not limited to, a gas or liquid. In a preferred embodiment, the shield is intended to provide thermal insulation and protection for the pipe, tube, conduit or the like. For example, possible uses for the invention are to insulate pipes carrying hot water, hot gas, steam, or some other fluid or material which is at a temperature higher than ambient. The shield could also be used to insulate a pipe carrying a fluid or other material which is at a temperature lower than ambient (e.g., liquid nitrogen or chilled water).

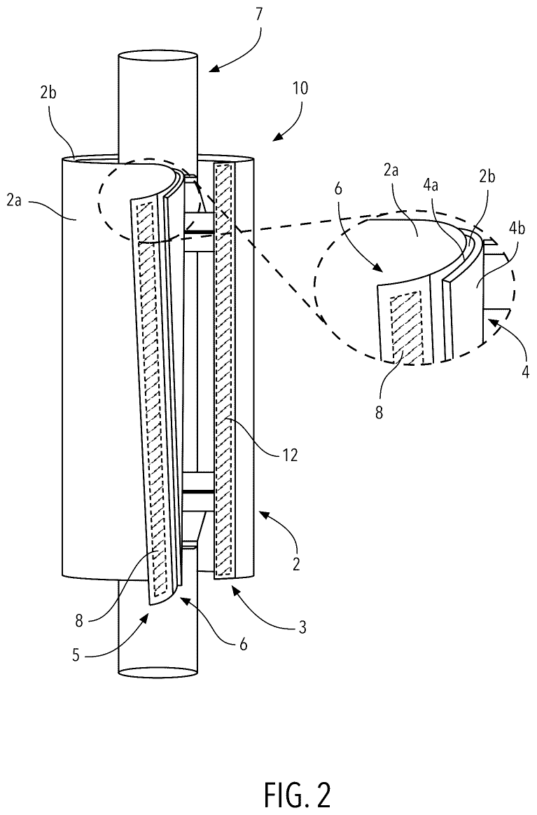

FIG. 2 is a perspective view of insulation shield 10 shown in FIG. 1, opened to show the layered construction and attachment means of insulation shield 10 (not drawn to scale). Insulation shield 10 comprises flexible outer jacket 2 having inner surface 2b and outer surface 2a, and insulation core 4 having inner surface 4b and outer surface 4a. It should be appreciated that in a preferred embodiment, the flexible outer jacket is comprised of vinyl coated polyester cloth, and the insulation core is comprised of closed cell ethylene-propylene-diene monomer based rubber elastomeric foam. First attachment means 12 is affixed to outer surface 2a of flexible outer jacket 2 proximate first end 3 of flexible outer jacket 2. Further, outer surface 4a of insulation core 4 is adhered to inner surface 2b of flexible outer jacket 2. In a preferred embodiment, outer surface 4a of insulation core 4 is adhered to inner surface 2b of flexible outer jacket 2 using acrylic pressure sensitive adhesive, however, other suitable adhesives such as epoxy, polyurethane, or other contact adhesives may be used to ensure secure and durable bonding that can withstand extreme temperatures, e.g., 40 °F-250 °F. Jacketing flap 6 extends from flexible outer jacket 2 proximate second end 5. Jacketing flap 6 has inner surface 6a and outer surface 6b. Jacketing flap 6 comprises second attachment means 8 affixed to inner surface 6a of jacketing flap 6 for securing insulation shield 10 around pipe 7, or alternatively, other structures that carry a fluid. In the preferred embodiment shown in FIG. 2, jacketing flap 6 is arranged to removably attach first attachment means 12 to second attachment means 8 in a single co-linear pair. This configuration ensures effective insulation and secure fastening. It should be appreciated that in a preferred embodiment the attachment means comprise hook and loop fasteners, but can also include other attachment means such as buttons, zippers, snaps, buckles, clasps, or other suitable mechanisms.

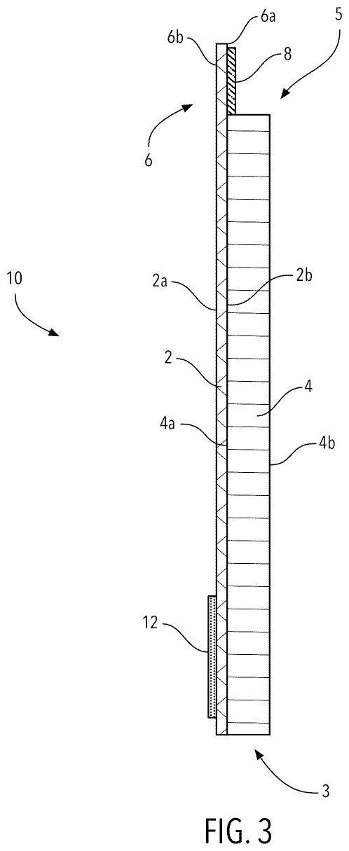

FIG. 3 is a top cross-sectional view of insulation shield 10 shown in FIG. 1. Flexible outer jacket 2 has inner surface 2b and outer surface 2a. Insulation core 4 has inner surface 4b and outer surface 4a, with outer surface 4a of insulation core 4 adhered to inner surface 2b of flexible outer jacket 2. Jacketing flap 6, having inner surface 6a and outer surface 6b, extends from flexible outer jacket 2 proximate second end 5 and comprises second attachment means 8. First attachment means 12 is affixed to outer surface 2a of flexible outer jacket 2 at first end 3 of flexible outer jacket 2. In a preferred embodiment, the attachment means are stitched onto the flexible outer jacket and jacketing flaps, however, it should be appreciated that the attachment means can be affixed to the flexible outer jacket and jacketing flaps using other suitable mechanisms, such as adhesives. FIG. 3 illustrates the relative thicknesses of flexible outer jacket 2 and insulation core 4. In a preferred embodiment, insulation core 4 will be thicker than flexible outer jacket 2.

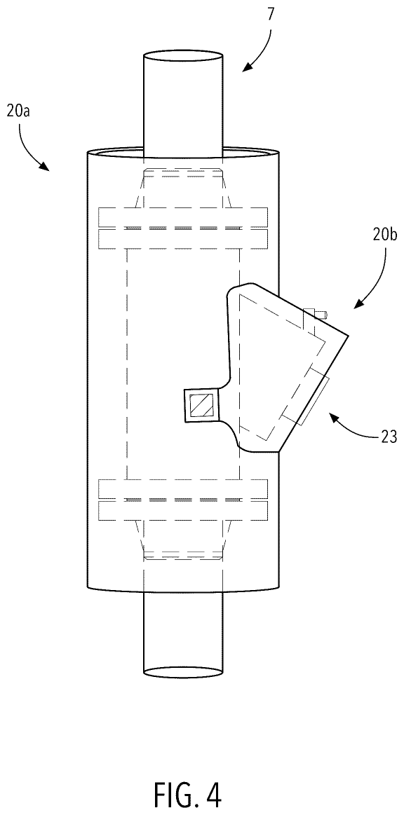

FIG. 4 is a perspective view of another embodiment of the present invention comprising insulation shield 20a and secondary insulation shield 20b. Secondary insulation shield 20b is positioned to provide additional insulation and protection around complex or irregular shaped components such as pipe component 23. It should be appreciated that secondary insulation shield 20b can provide additional insulation and protection to other complex or irregular shaped components including but not limited to, valves, flanges, elbows, plugs, couplings, bell reducers, bushings, sensors, caps, unions, tees, crosses, bonnets, etc., in a fluid carrying system.

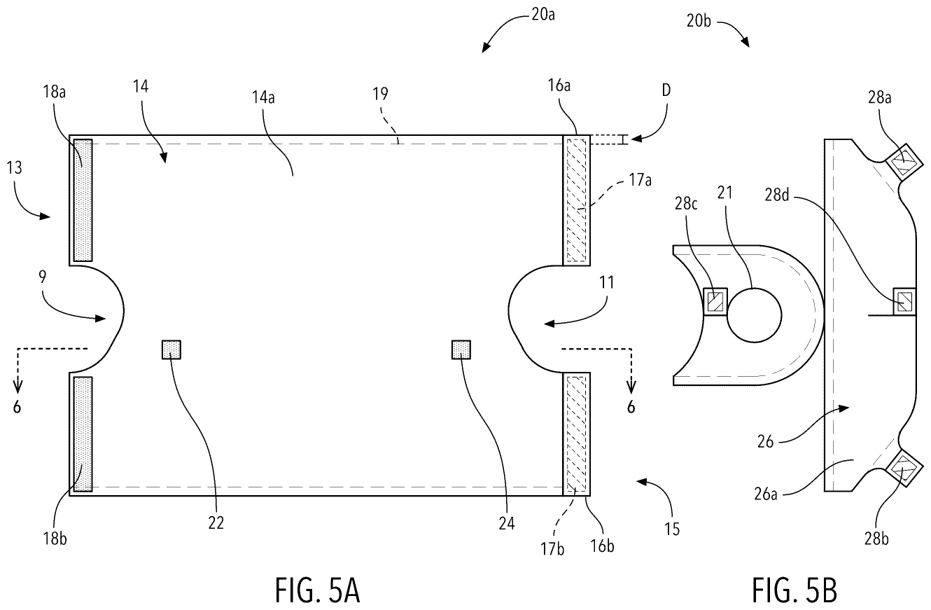

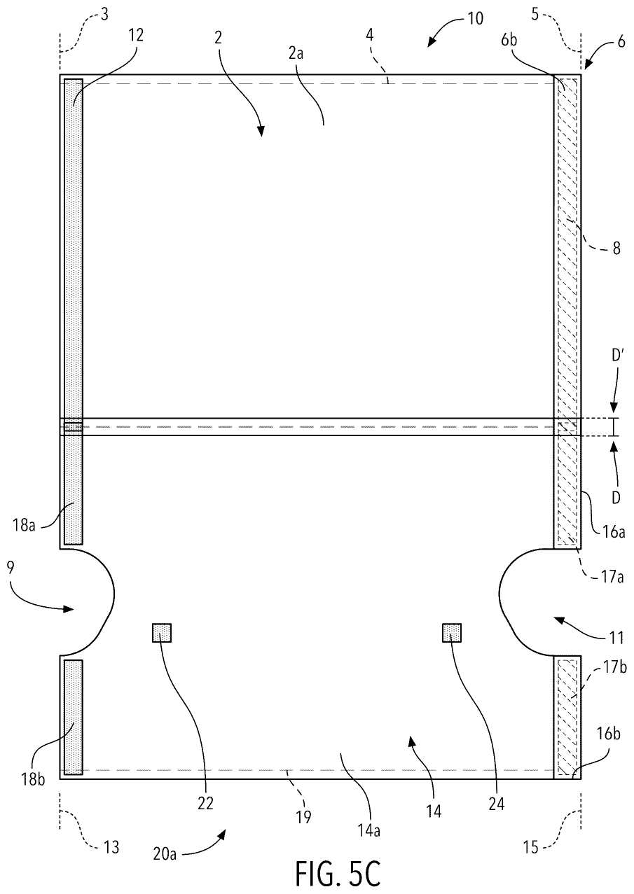

FIGS. 5A and 5B are side views of insulation shield 20a and secondary insulation shield 20b shown in FIG. 4, respectively, in a flattened uninstalled configuration. Insulation shield 20a comprises flexible outer jacket 14 having outer surface 14a. Further, insulation shield 20a comprises attachment means 22 and 24 within the periphery of outer surface 14a of flexible outer jacket 14. Insulation shield 20a also comprises first cutout 9 within flexible outer jacket 14 and insulation core 19 proximate first end 13 of flexible outer jacket 14, and second cutout 11 within flexible outer jacket 14 and insulation core 19 proximate second end 15 of flexible outer jacket 14. First cutout 9 divides first attachment means 12, shown in FIG. 2, into first pair of attachment means 18a and 18b. Second cutout 11 divides second attachment means 8, shown in FIG. 2, into pair of jacketing flaps 16a and 16b, and pair of attachment means 17a and 17b affixed to pair of jacketing flaps 16a and 16b, respectively. When insulation shield 20a is installed around a structure for carrying a fluid, such as a pipe, and attachment means 16a and 16b are engaged with attachment means 17a and 17b, cutouts 9 and 11 create an aperture for components extending from the structure for carrying a fluid. Secondary insulation shield 20b comprises flexible outer jacket 26 having outer surface 26a, jacketing flaps 28a, 28b, 28c, 28d, and aperture 21. When insulation shield 20a and secondary insulation shield 20b are installed together (as shown in FIG. 4), aperture 21 is aligned with the aperture formed by cutouts 9 and 11 to accommodate pipe component 23 to be accessible. It should be appreciated that in this configuration, secondary insulation shield 20b can accommodate other structures, e.g., valves, flanges, elbows, etc., to be accessible. Further, when installed together, insulation shield 20a and secondary insulation shield 20b are removably attached to one another by attaching jacketing flaps 28b and 28a to attachment means 22 and 24, respectively. FIG. 5A further shows flexible outer jacket 14 extending beyond insulation core 19 a distance D, enabling multiple insulation shields to overlap when installed adjacently, as shown in detail in FIG. 5C.

FIG. 5C is a side view of insulation shield 10 and insulation shield 20a showing the overlapping of the outer jackets of each insulation shield. When positioned adjacent to one another, outer jacket 2 of insulation shield 10 overlaps outer jacket 14 of insulation shield 20a, or vice versa, providing no open gap between insulation core 4 of insulation shield 10 and insulation core 19 of insulation shield 20a. Outer jacket 2 extends beyond insulation core 4 a distance D′, and outer jacket 14 extends beyond insulation core 19 a distance D, where D is substantially equal to D′.

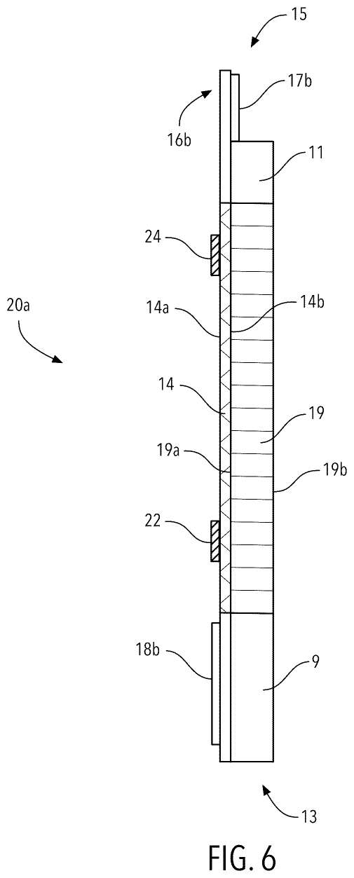

FIG. 6 is a top cross-sectional view of insulation shield 20a taken generally along line 6 -6 shown in FIG. 5A. Flexible outer jacket 14 has inner surface 14b and outer surface 14a. Insulation core 19 has inner surface 19b and outer surface 19a, with outer surface 19a of insulation core 19 adhered to inner surface 14b of flexible outer jacket 14. Jacketing flap 16b, extends from flexible outer jacket 14 proximate second end 15 and comprises attachment means 17b. Attachment means 18b is affixed to outer surface 14a of flexible outer jacket 14 proximate first end 13 of flexible outer jacket 14. Insulation shield 20a also comprises first cutout 9 within flexible outer jacket 14 and insulation core 19 proximate first end 13 of flexible outer jacket 14, and second cutout 11 within flexible outer jacket 14 and insulation core 19 proximate second end 15 of flexible outer jacket 14. Further, insulation shield 20a comprises attachment means 22 and 24 within the periphery of outer surface 14a of flexible outer jacket 14. FIG. 6 illustrates the relative thicknesses of flexible outer jacket 14 and insulation core 19. In a preferred embodiment, insulation core 19 will be thicker than flexible outer jacket 14.

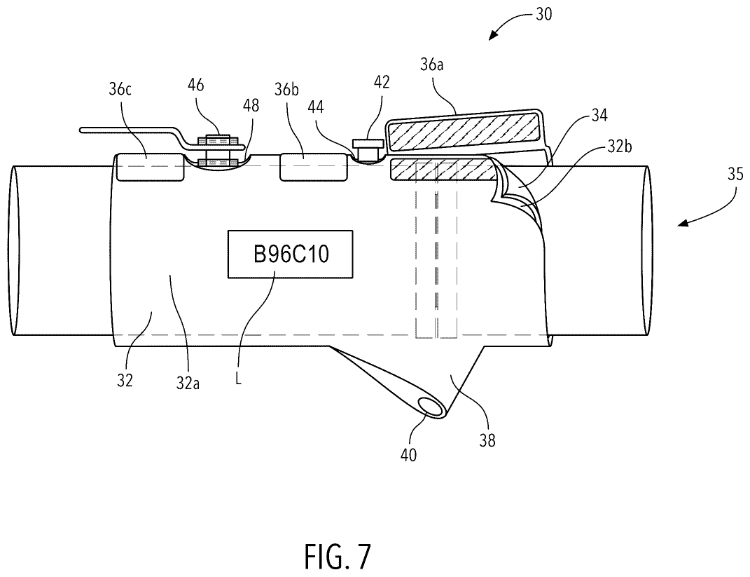

FIG. 7 is a perspective view of another embodiment of the present invention comprising insulation shield 30. Insulation shield 30 comprises flexible outer jacket 32 having outer surface 32a and inner surface 32b, and insulation core 34. Jacketing flaps 36a, 36b, and 36c, extend from flexible outer jacket 32 and provide means for securing insulation shield 30 around pipe 35. It should be appreciated that insulation shield 30 could be installed around other structures for carrying a fluid, e.g., a tube, conduit or the like. Jacketing flaps 36a, 36b, and 36c are positioned around apertures 44 and 48, which allow pipe components 42 and 46 to be accessible when insulation shield 30 is installed around pipe 35. To accommodate a leak and detect its origin, low point drain grommet 40 is housed within drain member 38. Drain member 38 is operatively arranged to direct liquids toward drain grommet 40. Label L is affixed to outer surface 32a of flexible outer jacket 32, providing a means for identifying and locating pipe 35 or other component being insulated.

The embodiments shown and described are merely exemplary and various alternatives, combinations, omissions of specific components, or foreseeable alternative components, understood by one having ordinary skill in the art, described in the present disclosure or within the field of the present disclosure, are intended to fall within the scope of the appending claims.

It will be appreciated that various aspects of the invention and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the claims.

### REFERENCE NUMERALS

2 Flexible outer jacket
2a Outer surface of outer jacket
2b Inner surface of outer jacket
3 First end
4 Insulation core
4a Outer surface of insulation core
4b Inner surface of insulation core
5 Second end
6 Jacketing flap
6a Inner surface of jacketing flap
6b Outer surface of jacketing flap
7 Pipe
8 Second attachment means
9 First cutout
10 Insulation shield
11 Second cutout
12 First attachment means
13 First end
14 Outer jacket
14a Outer surface of outer jacket
15 Second end
16a Jacketing flap
16b Jacketing flap
17a Attachment means
17b Attachment means
18a Attachment means
18b Attachment means
19 Insulation core
20a Insulation shield
20b Secondary insulation shield
21 Aperture
22 Attachment means
23 Pipe component
24 Attachment means
26 Flexible outer jacket
26a Outer surface of outer jacket
28a Jacketing flap
28b Jacketing flap
28c Jacketing flap
28d Jacketing flap
30 Insulation shield
32 Flexible outer jacket
32a Outer surface of outer jacket
32b Inner surface of outer jacket
34 Insulation core
35 Pipe
36a Jacketing flap
36b Jacketing flap
36c Jacketing flap
38 Drain member
40 Drain grommet
42 Pipe component
44 Aperture
46 Pipe component
48 Aperture
D Distance
D′ Distance
L Label

What is claimed is:

1. An insulation shield, comprising:
a flexible outer jacket having an inner surface and an outer surface, wherein the flexible outer jacket has a first attachment means affixed to the outer surface thereof and proximate a first end;
an insulation core having an inner surface and an outer surface, wherein the outer surface of the insulation core is adhered to the inner surface of the flexible outer jacket; and,
a jacketing flap having an inner surface and an outer surface, wherein:
the jacketing flap extends from a second end of the flexible outer jacket;
the jacketing flap has a second attachment means affixed to the inner surface of the jacketing flap; and,
the jacketing flap is arranged to removably attach to the first attachment means affixed to the outer surface of the flexible outer jacket.

2. The insulation shield recited in claim 1, wherein the flexible outer jacket is comprised of polyester cloth.

3. The insulation shield recited in claim 2, wherein the polyester cloth is vinyl coated.

4. The insulation shield recited in claim 1, wherein the insulation core is comprised of closed cell elastomeric foam.

5. The insulation shield recited in claim 4, wherein the closed cell elastomeric foam comprises closed cell ethylene-propylene-diene monomer based rubber elastomeric foam.

6. The insulation shield recited in claim 1, wherein the outer surface of the insulation core is adhered to the inner surface of the flexible outer jacket using acrylic pressure sensitive adhesive.

7. The insulation shield recited in claim 1, wherein both of the attachment means are arranged as a single co-linear pair.

8. The insulation shield recited in claim 1, wherein the attachment means comprise hook and loop fasteners.

9. The insulation shield recited in claim 1 further comprising a drain grommet, wherein the drain grommet is positioned within a lower portion of the insulation shield.

10. The insulation shield recited in claim 1, wherein the outer surface of the flexible outer jacket has a label for identification and location purposes for a component that the insulation shield is covering.

11. The insulation shield recited in claim 1, wherein the flexible outer jacket extends beyond the insulation core and the flexible outer jacket is operatively arranged to allow the flexible outer jacket of multiple insulation shields to overlap when positioned adjacently around structures for carrying a fluid, providing no open gap between the insulation cores of each insulation shield.

12. The insulation shield recited in claim 1 further comprising:
a first cutout within the flexible outer jacket and the insulation core proximate the first end of the flexible outer jacket; and,
a second cutout within the flexible outer jacket and the insulation core proximate the second end of the flexible outer jacket, wherein the first cutout divides the first attachment means into a first pair of attachment means and the second cutout divides the second attachment means into a second pair of attachment means, and wherein when the first pair of attachment means are engaged with the second pair of attachment means an aperture is formed therebetween.

13. The insulation shield recited in claim 12 further comprising the outer surface of the flexible outer jacket having one or more attachment means thereon within the periphery of the outer surface of the flexible outer jacket.

14. The insulation shield recited in claim 13 further comprising a secondary insulation shield removably attached over the aperture formed when the first and second pair of attachment means are engaged.

15. The insulation shield recited in claim 14, wherein the secondary insulation shield further comprises:
a flexible outer jacket comprised of vinyl coated polyester cloth, the outer jacket having an inner surface and an outer surface;
an insulation core comprised of closed cell ethylene-propylene-diene monomer based rubber elastomeric foam, the insulation core having an inner surface and an outer surface, wherein the outer surface of the insulation core is adhered to the inner surface of the flexible outer jacket using acrylic pressure sensitive adhesive;
an aperture; and,
attachment means operatively arranged to engage the one or more attachment means located on the outer surface of the flexible outer jacket within the periphery of the flexible outer jacket.

16. An insulation shield, comprising:
a flexible outer jacket comprised of vinyl coated polyester cloth, the outer jacket having an inner surface and an outer surface;
an insulation core comprised of closed cell ethylene-propylene-diene monomer based rubber elastomeric foam, the insulation core having an inner surface and an outer surface, wherein the outer surface of the insulation core is adhered to the inner surface of the outer jacket using acrylic pressure sensitive adhesive; and,
one or more jacketing flaps extending from a periphery of the outer jacket, the jacketing flaps further comprising attachment means thereon.

17. The insulation shield recited in claim 16, wherein the attachment means comprise hook and loop fasteners.

18. The insulation shield recited in claim 16 further comprising a drain grommet, wherein the drain grommet is positioned within a lower portion of the insulation shield.

19. The insulation shield recited in claim 16, wherein the outer surface of the flexible outer jacket has a label for identification and location purposes for a component that the insulation shield is covering.

20. The insulation shield recited in claim 16, wherein the flexible outer jacket extends beyond the insulation core and the flexible outer jacket is operatively arranged to allow the flexible outer jacket of multiple insulation shields to overlap when positioned adjacently around structures for carrying a fluid, providing no open gap between the insulation cores of each insulation shield.
